(19) United States
(12) Patent Application Publication
(10) Pub. No.: US 2026/0221049 A1
(43) Pub. Date: Jul. 30, 2026

(54) VEHICLE DRIVING SIMULATOR

(71) Applicant: Matan SHABAT, Eilat (IL)

(72) Inventor: Matan SHABAT, Eilat (IL)

(21) Appl. No.: 19/144,649

(22) PCT Filed: Jun. 30, 2023
(86) PCT No.: PCT/IL2023/051339

§ 371 Date: Jun. 30, 2025

(30) Foreign Application Priority Data
Dec. 30, 2022 (IL) 299607

(51) Int. Cl. G09B 9/052; G06F 3/01

(52) U.S. Cl. CPC G09B 9/052; G06F 3/016

(57) ABSTRACT

A vehicular driving simulation system utilizing magnetorheological fluid (‘MR’) and augmented reality to enhance the driving experience. The system includes an MR device which comprises: a) a housing having a receiving recess; b) at least one rotating disc internal to said housing; c) a magnetorheological fluid recess disposed about said at least one rotating disc; and d) at least one electromagnetic coil.

### FIELD OF THE INVENTION

The present invention relates to a device and system comprising a vehicle driving simulator, and in particular, to such a system utilizing augmented reality.

### BACKGROUND OF THE INVENTION

The use of simulation as a teaching and/or training tool is well known in various fields medicine, aviation and the like. Such simulation allows a user to gain experience while training both body and mind as to how to behave and/or react in various situations whether routine or unexpected.

### SUMMARY OF THE INVENTION

There is an unmet need for, and it would be highly useful to have, a system for motorized vehicle driving simulator that utilized augmented reality (herein ‘AR’) to provide a user with teaching and driving experience to gain appropriate driving skill(s) to operate a vehicle under various conditions and/or situations while enhancing the human driving experience under such variable conditions.

Embodiments of the present invention provide a device for vehicular driving simulation the device comprising:
a housing having a receiving recess;
at least one rotating disc internal to the housing;
a magnetorheological fluid (herein interchangeably referred to as ‘MR’ and/or ‘MRF’) recess disposed about the at least one rotating disc; and
at least one electromagnetic coil.

In embodiments, the receiving recess may be configured to receive and associate with at least a portion of a vehicle control assembly member.

In embodiments, the vehicle control assembly member may be for example include but is not limited to at least one or more of: steering wheel shaft, steering wheel, a portion of a steering wheel assembly, foot pedal, foot pedal shaft, a portion of a foot pedal assembly, stick shift shaft, a portion of stick shift assembly, the like or any combination thereof.

In embodiments, the receiving recess may be configured to be concentric with the rotatable disc.

In embodiments, the MR fluid recess may be configured to receive a MR fluid.

In embodiments, the MR fluid recess surrounds the rotatable disc.

In embodiments, the device may be configured to comprise at least two or more electromagnetic coil arranged peripherally about the device housing.

In embodiments, the device may be configured such that the MR fluid recess may be disposed between the at least one electromagnetic coil and the at least one rotating disc. Optionally, within the device housing, the coil may be configured to be disposed peripheral and/or external to the MR fluid recess and the rotating disc may be configured to be central and/or internal to the MR fluid recess with respect to the device housing. Optionally, within the device housing, the coil may be configured to be disposed central and/or internal to the MR fluid recess and the rotating disc may be configured to be disposed peripheral and/or external to the MR fluid recess, with respect to the device housing.

In embodiments, the MR fluid recess may be configured to have a comb like surface.

In embodiments, the MR fluid recess may be configured to have a high surface area along at least one dimension.

In embodiments, the MR fluid recess may be configured to have a high surface area to volume ratio.

In embodiments, the device may be configured to further comprise a return spring module.

Embodiments of the present invention provide a system for vehicular driving simulation, the system comprising:
a device for vehicular driving simulation the device as previously described having a MR fluid recess;
a vehicle body seat housing module;
a visual display module;
a sensor module;
an electronics and circuitry module; and
an augmented reality (AR) module.

In embodiments, the system may further comprise a head gear module.

In embodiments, the system may further comprise a body suit module.

In embodiments, the head gear module may be provided in the form of a wearable helmet.

In embodiments, the system head gear module may further comprise at least one internal facing camera and/or one external facing camera.

In embodiments, the system may further comprise at least one or more haptic wearable sensory devices.

In embodiments, the body suit module may be configured in the form of a wearable racing suit. Optionally,

In embodiments, the body suit module may feature a sensor module.

In embodiments, the body suit module may feature and/or may be integrated with at least one or more haptic wearable sensory devices.

In embodiments, the body suit module may be configured in optional forms for example including but not limited to the form of a belt wearable along any portion of a user's (driver) body.

In embodiments, the body suit module may be associated with and/or functionally coupled with the system's sensor module.

In embodiments, the sensor module may be configured to monitor physiological data related to the user. Optionally, the physiological data may for example include but is not limited to at least one or more of: temperature, heart rate, blood pressure, pupil dilation, pressure, tension, sweat, perspiration rate, visual focal point, the like or any combination thereof.

In embodiments, the vehicle body seat housing module optionally and preferably features a user tethering device for example provided in the form of at least one of: belt, straps, seat belt assembly, a five point seat belt assembly, the like or any combination thereof. In optional embodiment, the tension in the tethering device may be controllable with at least one of the electronics module and/or the sensor module.

In embodiments, the vehicle body seat housing module may be configured to feature a headrest optionally and preferably comprising at least one or more user feedback device.

In embodiments, the vehicle body seat housing module may feature at least one or more haptic wearable devices useable with any portion of a user's body.

In embodiments, the vehicle body seat housing module may feature at least one or more speakers.

In embodiments, the AR module may be provided in the form of a wearable device for example including but not limited to a visual display, glasses or the like.

In embodiments, the AR module may optionally be integrated with the head gear module, wherein the head gear module features an AR enabled visor and/or display.

In embodiments, the AR module may be configured to display to a user guiding information related to driving performance data.

In embodiments, the driving performance data may for example include but is not limited to at least one of: line of driving, braking point, acceleration points, speed, sight line, visual focal points, the like or any combination thereof.

In embodiments, the guiding information may relate to a user real-time simulator performance data in relation to offline target data. Optionally, offline target data may be related to recorded on-road driver performances. Optionally, on-road driver performances may be related to particular exemplary drivers such as favorite race car drivers, driving instructors, celebrity or the like.

In embodiments, the driving data provides for relating to a user a comparative driving skill level with respect to other drivers, therein optionally and preferably allowing for scoring and/or performance scoring.

In embodiments, haptic sensors and devices as used within the context of this invention provide for tactile force sensing of any portion the vehicle and/or user.

In embodiments, the visual sensors such as cameras provide for spatial and/or positional referencing allowing for identifying the users eye position, hand position, foot position, in different situations.

In embodiments, any portion of the device and/or system and/or the augmented reality module may comprise at least one or more camera, GPS capabilities, and/or mapping capabilities.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary device and system according to embodiments of the present invention; and

FIG. 2. is a schematic illustrative diagram of an exemplary device according to embodiments of the present invention.

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.
100 System;
102 Vehicle Body Seat Housing Module;
104 Display Module ;
110 Electronics Module;
120 Sensor Module;
130 Head Gear module;
140 Body Suit module;
150 MR Device;
152 housing;
154 MR fluid housing/recess;
155 Receiving Recess;
156 electromagnetic (EM) coil(s);
158 Rotating Disc;
159 Return Spring Module;
160 Augmented Reality Module;

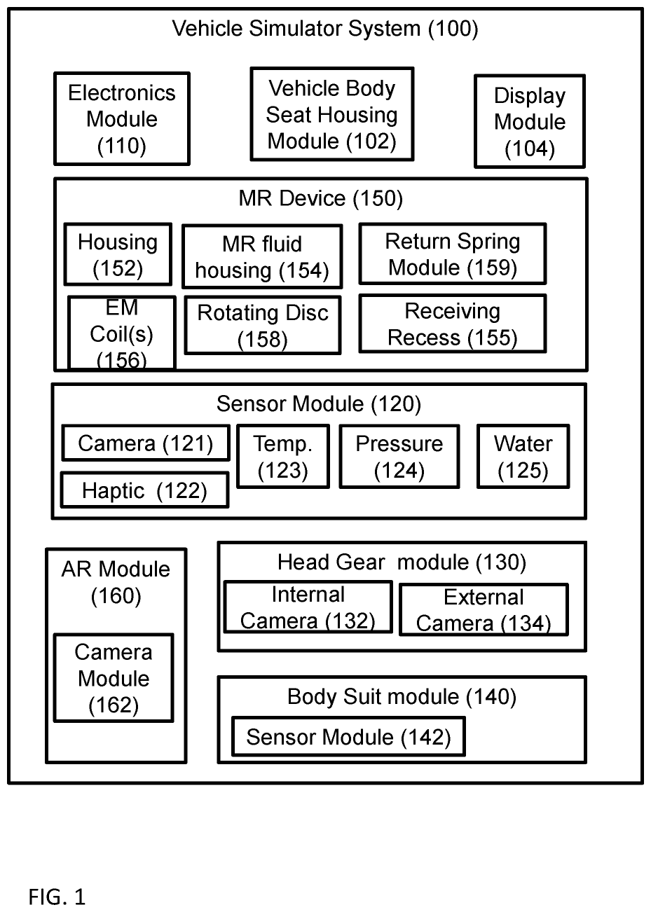

FIG. 1 shows a schematic block diagram of an exemplary system 100 according to the present invention. System 100 for a vehicular driving simulation having augmented reality capabilities. The system 100 provides for interactively displaying to a user driving performance with respect to optional driving parameters for example including but is not limited to at least one of: line of driving, braking point, acceleration points, speed, sight line, visual focal points, the like or any combination thereof. The vehicle driving performance is conveyed to a user so as to improve driving ability. In embodiments, the guiding information may relate to a user real-time simulator performance data in relation to offline targeted driving performance data. Optionally, offline target data may be related to recorded on-road driver performances. Optionally, on-road driver performances may be related to particular exemplary drivers such as favorite race car drivers, driving instructors, expert drivers, celebrity or the like.

The system provides realistic driving experience by immersing the user (driver) providing the look and feel of a real driving experience so as to improve driving performance. Driving performance may be taught by conveying to a user the driving performance parameters both in a tactile sense where the different vehicle controllers, steering wheel, pedals, stick shift are configured to behave as they would in real-life road situations.

Embodiments of the present invention provide a system for vehicular driving simulation and experience, the system comprising:
a device 150 for vehicular driving simulation the device as described below the device 150 having a MR fluid recess 154 so as to enable control of feel of various vehicle control assemblies, for example including but not limited to foot pedals, steering wheel, stick shift, or the like; and
a vehicle body seat housing module 102 providing a realistic vehicle body and/or seat to interface with the user;
a visual display module 104 for example provided in the form of a display emulating the windshield of a vehicle; and
a sensor module 120 featuring a plurality of optional sensor for obtaining and conveying data associated with a user, user performance and vehicle performance;
an electronics and circuitry module 110 so as to render the system and devices operational;
an augmented reality (AR) module 160 comprising at least one AR enabled device and sensors providing for interfacing with the user.

In some embodiments, system 100 may further comprise a head gear module 130, for example in the form of a helmet or the like wearable head based devices such as headphones, glasses, protective gear or the like.

In some embodiments, the system 100 may further comprise a body suit module 140.

In embodiments, the head gear module 130 may optionally be provided in the form of a wearable helmet. In embodiments, the head gear module 130 may further comprise at least one internal facing camera 132 and/or one external facing camera 134. Optionally and preferably internal facing camera 132 may be configured to provide user eye data for example including but not limited to dilation, visual sight (near or far), sightline, the like or any combination therein. Optionally external camera 134 may provide for conveying to a user external data such as foot positioning, head tilt positioning, or the like. Optionally, head gear module 130 may further comprise additional sensors such as perspiration sensor, heart rate sensor, blinking rake, temperature, pressure sensor, or the like sensor for conveying bodily performance during driving.

In embodiments, the system 100 may further comprise at least one or more haptic wearable sensory devices along any portion or module of system 100.

In embodiments, the body suit module 140 may be configured in the form of a wearable racing suit.

In embodiments, the body suit module 140 may feature a sensor module 142, the sensory module 142 may comprise sensors of optional forms for example including but not limited to haptic sensors, perspiration sensor, heart rate sensor, blinking rake, temperature, pressure sensor, galvanic skin conductance sensor, or the like sensor for conveying bodily performance during driving.

In embodiments, the body suit module 140 may feature and/or may be integrated with at least one or more haptic wearable sensory devices.

In embodiments, the body suit module 140 may be configured in optional forms for example including but not limited to the form of a belt wearable along any portion of a user's (driver) body.

In embodiments, the body suit module 140 may be associated with and/or functionally coupled with the system's sensor module 120.

In embodiments, the sensor module 120 may be configured to monitor physiological data related to the user. Optionally, the physiological data may for example include but is not limited to at least one or more of: camera 121, haptic sensor 122, temperature sensor 123, heart rate sensor, blood pressure, pupil dilation, pressure 124, tension, sweat, perspiration rate 125, galvanic skin conduction, visual focal point, the like or any combination thereof.

In embodiments, the vehicle body seat housing module 102 optionally and preferably features a user tethering device for example provided in the form of at least one of: belt, straps, seat belt assembly, a five point seat belt assembly, the like or any combination thereof. In optional embodiment, the tension in the tethering device may be controllable with at least one of the electronics module and/or the sensor module.

In embodiments, the vehicle body seat housing module 102 may be configured to feature a headrest optionally and preferably comprising at least one or more user feedback device.

In embodiments, the vehicle body seat housing module 120 may feature at least one or more haptic wearable devices useable with any portion of a user's body.

In embodiments, the vehicle body seat housing module 120 may feature at least one or more speakers.

In embodiments, the augmented reality (AR) module 160 may be provided in the form of a wearable device for example including but not limited to a visual display, glasses or the like.

In embodiments, the AR module 160 may optionally be integrated with the head gear module 130, wherein the head gear module features an AR enabled visor and/or display.

In embodiments, the AR module 160 may be configured to display to a user guiding information related to driving performance data.

In embodiments, the driving performance data may for example include but is not limited to at least one of: line of driving, braking point, acceleration points, speed, sight line, visual focal points, the like or any combination thereof.

In embodiments, the guiding information may relate to a user real-time simulator performance data in relation to offline target data. Optionally, offline target data may be related to recorded on-road driver performances. Optionally, on-road driver performances may be related to particular exemplary drivers such as favorite race car drivers, driving instructors, celebrity or the like.

In embodiments, the driving data provides for relating to a user a comparative driving skill level with respect to other drivers, therein optionally and preferably allowing for scoring and/or performance scoring.

In embodiments, haptic sensors and devices as used within the context of this invention provide for tactile force sensing of any portion the vehicle and/or user.

In embodiments, the visual sensors such as cameras provide for spatial and/or positional referencing allowing for identifying the users eye position, hand position, foot position, in different situations.

In embodiments, any portion of the device and/or system and/or the augmented reality module may comprise at least one or more camera, GPS capabilities, and/or mapping capabilities.

In embodiments electronics module 110 may comprise a plurality of optional sub-modules for example including but not limited to a power supply module 112, controller and/or processor module 114, user interface module 111, and memory module 118. Optionally electronics module 110 may further comprise a communication module 116. Electronics module 110 may further be functionally associated with sensor module 120.

In embodiments, User Interface (UI) module 111 may provide a user with means for interfacing with device 100 preferably via processor module 114. User interface 111 is preferably provided in the form of an audiovisual display. In embodiments, UI module 111 may be provided in optional forms for example including but not limited to keyboard, display, touch screen, touch pad, buzzer, tactile pad, at least one light emitting diode (LED), at least one organic LED (OLED), speakers, microphone, or any combination thereof.

In embodiments processor module 114 provides the necessary processing hardware and/or software necessary to render device 150 and system 100 functional. In embodiments controller and/or processor module 114 may provide for controlling any portion of device 150 and/or system. For example, processor 114 may be utilized to determine driving parameters and analysis based on a sensed event in the vicinity of system 100 and/or device 150.

In embodiments power module 112 provides the necessary hardware and/or software to power system 100 and/or device 150 rendering system 100 and device 150 operational. Power supply 112 may for example be provided in optional forms for example including but not limited to battery, rechargeable induction battery, induction coil, capacitors, super capacitors, the like power source or any combination thereof.

In embodiments communication module 116 provides the necessary hardware and/or software to facilitate communication for device 150 and system 100 to communicate with optional devices and/or modules.

In some embodiments communications module 116 may be utilize to provide device 150 and/or system 100 with communication capabilities. For example, communication sub-module 116 may provide for communication with devices and or systems by utilizing various communication protocols for example including but not limited to wireless communication protocols, cellular communication, wired communication, near field communication, Bluetooth, optical communication, the like and/or any combination thereof.

In embodiments memory module 118 provides the necessary hardware and/or software to facilitate operations of device 150 and/or system 100 by enabling storing and/or retrieving stored data and/or the like as is known in the art.

In some embodiments sensor module 120 provides the necessary hardware and/or software to facilitate operations of at least one or more sensor(s) associated with device 150 and/or system 100 to enable sensing various events in and around user and/or system 100. In embodiments sensor module 120 may comprise at least one or more sensor selected from the group consisting of: temperature sensor, pH sensor, galvanic skin conductance sensor, heart rate sensor, flow-meter, haptic sensor, pulse oximeter, piezoelectric pressure sensor, pressure sensor, the like or any combination thereof.

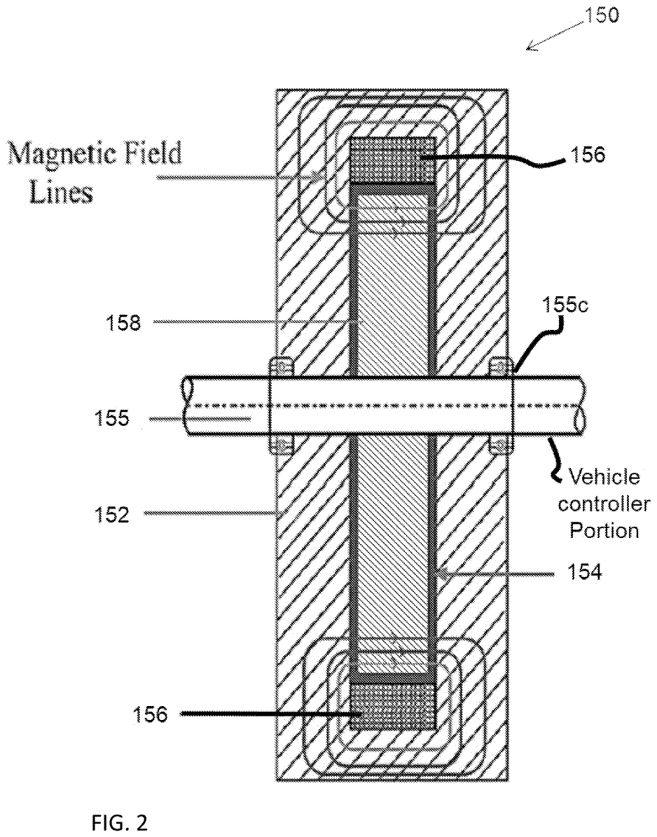

FIG. 2 shows a schematic illustration of an embodiment of the present invention for a magnetorheological fluid (‘MR’/‘MRF’) device 150 configured for vehicular driving simulation to properly convey to a user (driver) simulated driving experience so as to improve performance and/or teach driving skills. Optionally the skills are taught relative to a particular celebrity driver, driver, driver instructor or the like expert driver to improve the simulators user's skill set.

As shown device 150 comprises a housing 152 having a receiving recess 155 configured for associating the device to a portion of a vehicle functional controllers for example including but not limited to steering wheel, stick shift, driving pedal or the like. Device 150 provide for controlling the weight distribution and look and feel of the device associated therewith so as to properly convey to a user how the functional controlling unit behaves under different driving conditions.

In embodiments housing 152 may be coupled to a vehicle functional controller portion via a receiving recess 155 with at least one or more coupling member 155c.

Device 150 comprises at least one rotating disc 158 disposed internal to the housing. Optionally and preferably rotating disc is associated with the vehicle functional controller portion, for example as shown in the form of a steering wheel shaft.
Device 150 comprises a magnetorheological fluid (‘MR’/‘MRF’) recess 154 featuring at least one or more MR fluid(s) that are preferably responsive to magnetic fields, preferably generated by a portion of device 150, wherein the magnetic fields provides for controlling the MR fluid properties most preferably viscosity. Therein to increase and/or decrease the viscosity of the MR fluid so as to provide for controlling the weight and/or force distribution of device 150 and its associated vehicle functional controlling device.
In embodiment, the magnetic fields generated with device 150 may be generated with at least one or more electromagnetic coil(s) 156 disposed adjacent to the MR fluid recess and the rotatable disc 158. Preferably as disc 158 rotates within housing 152 adjacent to at least one or more coils 156 to preferably generate a magnetic field so as affect the fluid properties of the MR fluid disposed with MR fluid housing based on the generated magnetic field.

In embodiments, the receiving recess 155 may be configured to receive and associate with at least a portion of a vehicle control assembly member. The vehicle control assembly member may for example include but is not limited to at least one or more of: steering wheel shaft (FIG. 2), steering wheel, a portion of a steering wheel assembly, foot pedal, foot pedal shaft, a portion of a foot pedal assembly, stick shift shaft, a portion of stick shift assembly, the like or any combination thereof.

In embodiments, the receiving recess 155 may be configured to be concentric with the rotatable disc 158.

In embodiments, the MR fluid recess 154 is preferably configured to receive at least one or more MR fluid(s).

In embodiments, the MR fluid recess 154 may be configured to surround the rotatable disc 158.

In embodiments, the device 150 may be configured to comprise at least two or more electromagnetic coils 156 that may be arranged peripherally about the device housing, for example as shown FIG. 2.

In embodiments, device 150 may be configured such that the MR fluid recess 154 may be disposed between the at least one electromagnetic coil 156 and the at least one rotating disc 158. Optionally, within the device housing 152, the coil 156 may be configured to be disposed peripheral and/or external to the MR fluid recess 154 and the rotating disc 158 may be configured to be central and/or internal to the MR fluid recess 154 with respect to the device housing 152. Optionally, within the device housing 152, the coil 156 may be configured to be disposed central and/or internal to the MR fluid recess 154 and the rotating disc 158 may be configured to be disposed peripheral and/or external to the MR fluid recess 154, with respect to the device housing 152.

In embodiments, the MR fluid recess 154 may be configured to have a comb like surface.

In embodiments, the MR fluid recess 154 may be configured to have a high surface area along at least one dimension.

In embodiments, the MR fluid recess 154 may be configured to have a high surface area to volume ratio.

In embodiments, the device 150 may be configured to further comprise a return spring module 159 allowing for reciprocating user behavior to and from the simulating system 100.

As used herein the term “about” refers to +/−10 %.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B”or “A and B.”

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It should be noted that where reference numerals appear in the claims, such numerals are included solely or the purpose of improving the intelligibility of the claims and are no way limiting on the scope of the claims.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

While the invention has been described with respect to a limited number of embodiments, it will be appreciated that many variations, modifications and other applications of the invention may be made.

What is currently claimed is:

1) A device for vehicular driving simulation the device comprising:
a) a housing having a receiving recess;
b) at least one rotating disc internal to said housing;
c) a magnetorheological fluid (‘MR’) recess disposed about said at least one rotating disc; and
d) at least one electromagnetic coil.

2) The device of claim 1 wherein said receiving recess is configured to receive and associate with at least a portion of a vehicle control assembly member.

3) The device of claim 1 wherein said vehicle control assembly member is selected from at least one or more of: steering wheel shaft; steering wheel; a portion of a steering wheel assembly; foot pedal ; foot pedal shaft; a portion of a foot pedal assembly; stick shift shaft; a portion of stick shift assembly; or any combination thereof.

4) The device of claim 1 wherein said receiving recess is concentric with said rotatable disc.

5) The device of claim 1 wherein said MR fluid recess is configured to receive a MR fluid.

6) The device of claim 1 wherein said MR fluid recess surrounds said rotatable disc.

7) The device of claim 1 comprising at least two or more electromagnetic coil arranged peripherally about said device housing.

8) The device of claim 1 wherein said MR fluid recess is disposed between said at least one electromagnetic coil and said at least one rotating disc.

9) The device of claim 8 wherein said coil is peripheral/external to said MR fluid recess and said rotating disc is central/internal to said MR fluid recess.

10) The device of claim 8 wherein said coil is central/internal to said MR fluid recess and said rotating disc is peripheral/external to said MR fluid recess.

11) The device of claim 1 wherein said MR fluid recess is configured to have a comb like surface.

12) The device of claim 1 wherein said MR fluid recess is configured to have a high surface area along at least one dimension.

13) The device of claim 1 wherein said MR fluid recess is configured to have a high surface area to volume ratio.

14) The device of claim 1 comprising a return spring module.

15) A system for vehicular driving simulation, the system (100) comprising:
a) the device (150) according to any one of claims 1-14;
b) a vehicle body seat housing module (102);
c) display module (104);
d) sensor module (120);
e) electronics and circuitry module (110); and
f) an augmented reality (AR) module (160).

16) The system of claim 15 further comprising a head gear module (130).

17) The system of claim 15 further comprising a body suit module (140).

18) The system of claim 15 further comprising a head gear module (130) and a body suite module (140).

19) The system of claim 16 wherein said head gear module (130) is provided in the form of a wearable helmet.

20) The system of claim 16 comprising at least one internal facing camera (132) and one external facing camera (134).

21) The system of claim 16 further comprising at least one or more haptic wearable sensory devices.

22) The system of claim 17 wherein said body suit module (140) is configured in the form of a wearable racing suit.

23) The system of claim 17 wherein said body suit module (140) features a sensor module (142).

24) The system of claim 17, 21-22 wherein said body suit module (140) features at least one or more haptic wearable sensory devices.

25) The system of claim 17 wherein said body suit module (140) is configured in the form of a belt.

26) The system of claim 17 wherein said body suit module (140) is associated with said sensor module (120).

27) The system of claim 26 wherein said sensor module is configured to monitor physiological data related to the user.

28) The system of claim 26 wherein said physiological data is selected form at least one of: temperature, heart rate, blood pressure, pupil dilation, pressure, tension, sweat, perspiration rate, visual focal point, or any combination thereof.

29) The system of claim 15 wherein said vehicle body seat housing module (102) features a user tethering device in the form of at least one of: belt, straps, seat belt assembly, a five point seat belt assembly or the like.

30) The system of claim 24 wherein the tension in said tethering device is controllable with at least one of said electronics module (110) and/or said sensor module (120).

31) The system of claim 15 wherein said vehicle body seat housing module (102) features a headrest having user feedback devices.

32) The system of claim 15 wherein said vehicle body seat housing module (102) features haptic wearable devices useable with any portion of a user's body.

33) The system of claim 15 wherein said vehicle body seat housing module (102) features at least one or more speakers.

34) The system of claim 15 wherein said AR module is provided in the form of a wearable device.

35) The system of claim 32 wherein the wearable device is glasses.

36) The system of claim 16 wherein said AR module (160) is integrated with said head gear module (130), wherein said head gear module features an AR enabled visor and/or display.

37) The system of any one of claims 32-34 wherein said AR module is configured to display to guiding information related to driving performance data.

38) The system of claim 35 wherein said driving performance data comprises at least one of: line of driving, braking point, acceleration points, speed, sight line, visual focal points, the like or any combination thereof.

39) The system of claim 35 wherein said guiding information relates to a user real-time simulator performance data in relation to offline target data.

40) The system of claim 37 wherein said offline target data is related to recorded on-road driver performances.
